(19) United States
(12) Patent Application Publication
(10) Pub. No.: US 2024/0428986 A1
(43) Pub. Date: Dec. 26, 2024

(54) COIL UNIT

(71) Applicant: HONDA MOTOR CO., LTD., Tokyo (JP)

(72) Inventor: Tetsu Sato, Wako-shi (JP)

(21) Appl. No.: 18/676,533

(22) Filed: May 29, 2024

(30) Foreign Application Priority Data
Jun. 26, 2023 (JP) 2023-104433

(51) Int. Cl. H01F 27/30; H02J 50/10

(52) U.S. Cl. CPC H01F 27/306; H02J 50/10

(57) ABSTRACT

A coil unit includes: a coil; a housing that accommodates the coil; and an inner member that is inserted in an empty core region of the coil. The coil transmits electric power in a contactless manner to an electric power reception device. The housing is fixed to a rear surface of a lid of a manhole buried in the ground of a travel path. The inner member protrudes to the outside through the housing. A surface of the inner member is exposed to the outside from a surface of the lid portion.

### CROSS-REFERENCE TO RELATED APPLICATION

Priority is claimed on Japanese Patent Application No. 2023-104433, filed on Jun. 26, 2023, the contents of which are incorporated herein by reference.

### BACKGROUND

### Field of the Invention

The present invention relates to a coil unit.

### Background

In recent years, in order to ensure that more people have access to affordable, reliable, sustainable, and advanced energy, research and development relating to charging and electric power supply in a vehicle on which a secondary battery is mounted, which contributes to energy efficiency, has been conducted.

In the related art, in a system that supplies electric power to a vehicle from the outside of the vehicle by contactless electric power transmission, an electric power supply-side unit is known which includes a support base provided on a road surface and an electric power supply pad that is suspended from a top plate which covers a recess portion formed on the support base (for example, refer to Japanese Unexamined Patent Application, First Publication No. 2014-239168).

### SUMMARY

In techniques relating to charging and electric power supply in a vehicle on which a secondary battery is mounted, when performing contactless electric power transmission to the vehicle, it is desired to improve ease of maintenance of a device on an electric power transmission side while ensuring a desired output and efficiency of charging and electric power supply. For example, in the electric power supply-side unit of the related art described above, in order to ensure travel safety of the vehicle on a travel path, when the support base is buried in the travel path, there is a problem in that a complicated tasks are required for various maintenance work with respect to the device and a member on the electric power transmission side.

An aspect of the present invention aims to provide a coil unit capable of improving ease of maintenance of a device and a member on an electric power transmission side while ensuring a desired output and efficiency of charging and electric power supply. Further, the aspect of the present invention contributes to energy efficiency.

A coil unit according to a first aspect of the present invention includes: a coil that transmits electric power in a contactless manner to an electric power reception device; and a housing that accommodates the coil, wherein the housing is fixed inside a hole portion formed in a travel path to a lid portion which closes an open end of the hole portion.

A second aspect is the coil unit according to the first aspect described above which may include an inner member that is inserted in an empty core region of the coil and protrudes to the outside through the housing, wherein a surface of the inner member may be exposed to the outside from a surface of the lid portion.

A third aspect is the coil unit according to the first or second aspect described above, wherein the hole portion may be formed of a cylindrical member buried in the ground, and the lid portion may close an open end of the cylindrical member.

According to the first aspect described above, by including the housing that is fixed inside the hole portion of the travel path to the lid portion, for example, it is possible to prevent a direct load by a vehicle on the travel path or the like from acting and improve durability while ensuring a desired output and efficiency of charging and electric power supply. The housing is integrally fixed to the lid portion and can be therefore easily exposed to the outside by being removed together with the lid portion. Further, for example, various devices, members, and the like that are arranged inside the hole portion can be easily exposed to the outside by the removal of the lid portion. Thereby, it is possible to improve ease of various maintenance work.

In the case of the second aspect described above, by including the inner member that is exposed to the outside from the surface of the lid portion, for example, it is possible to prevent an efficiency decrease of electric power transmission compared to the case where the coil unit is buried under an asphalt or concrete pavement, for example.

In the case of the third aspect described above, in addition to the housing and the coil, for example, various devices, members, and the like that constitute an electric power transmission apparatus of a contactless electric power transmission system can be arranged, for example, inside the cylindrical member buried in the ground such as an existing manhole or a hand-hole.

### BRIEF DESCRIPTION OF THE DRAWINGS

FIG. 1 is an exploded perspective view showing a configuration of a coil unit in an embodiment of the present invention.

FIG. 2 is a perspective view showing the configuration of the coil unit in the embodiment of the present invention.

FIG. 3 is a cross-sectional view showing the coil unit in the embodiment of the present invention cut by an X-Z plane at a position of an A-A line shown in FIG. 1 and FIG. 2.

### DESCRIPTION OF EMBODIMENTS

Hereinafter, a coil unit according to an embodiment of the present invention will be described with reference to the attached drawings.

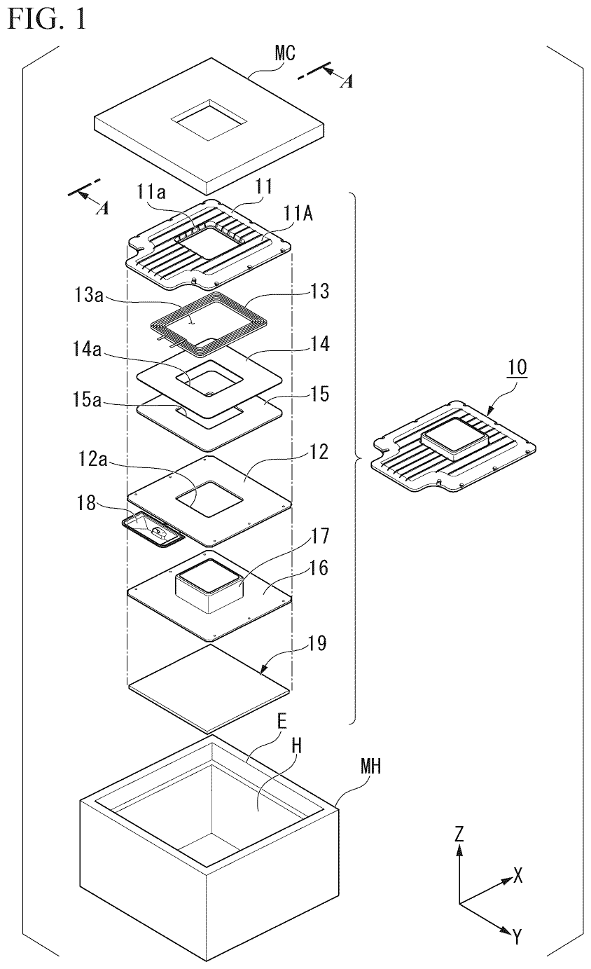

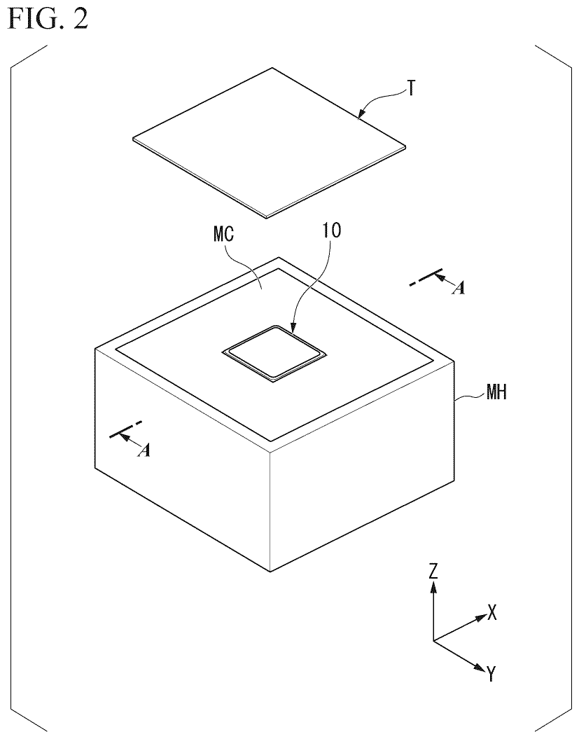

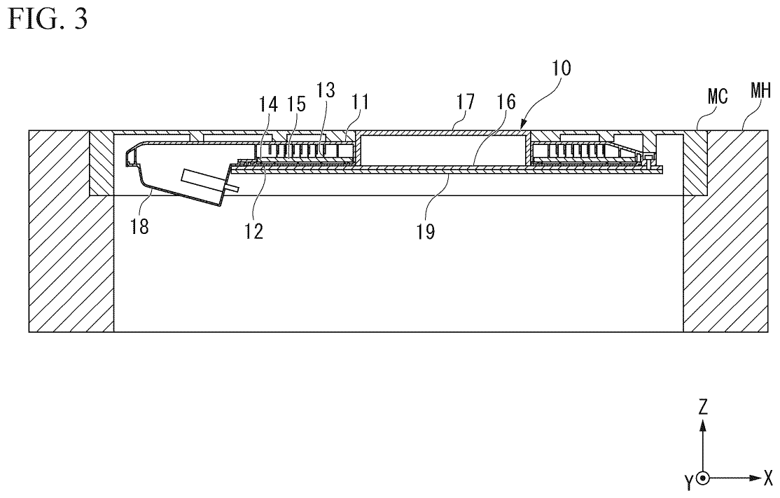

FIG. 1 is an exploded perspective view showing a configuration of a coil unit 10 in an embodiment. FIG. 2 is a perspective view showing the configuration of the coil unit 10 in the embodiment. FIG. 3 is a cross-sectional view showing the coil unit 10 in the embodiment cut by an X-Z plane at a position of an A-A line shown in FIG. 1 and FIG. 2.

Hereinafter, each axis direction of the X-axis, the Y-axis, and the Z-axis orthogonal to one another in a three-dimensional space is a direction parallel to each axis of the coil unit 10. For example, as shown in FIG. 1 to FIG. 3, the Z-axis direction is parallel to an upward-downward direction of the coil unit 10 such as a vertical direction, and the X-axis direction and the Y-axis direction are directions orthogonal to the upward-downward direction of the coil unit 10 such as a horizontal direction.

The coil unit 10 of the embodiment constitutes, for example, part of a contactless electric power transmission system that supplies electric power from the outside of a movable body such as a vehicle to an electric power reception device T of the movable body by contactless electric power transmission. The coil unit 10 of the embodiment is provided, for example, on an electric power transmission apparatus provided on a travel path of a vehicle or the like.

The coil unit 10 of the embodiment is fixed, for example, to a lid MC of a manhole MH (cylindrical member) having a rectangular cylindrical form buried under the ground of the travel path of the vehicle or the like. The coil unit 10 is suspended by a lower surface (rear surface) of the lid MC, for example, by an appropriate fastening member, an appropriate elastic member, or the like. The lid MC of the manhole MH is formed of, for example, a resin material, a fiber material, and the like. The lid MC closes an upper open end of the manhole MH. For example, various devices and members that constitute the electric power transmission apparatus of the contactless electric power transmission system are accommodated in an inner space H (hole portion) of the manhole MH.

As shown in FIG. 1, FIG. 2, and FIG. 3, the coil unit 10 includes, for example, a housing 11, a first cover 12, a coil 13, an insulation member 14, a core member 15, a back member 16, an inner member 17, a second cover 18, and a support member 19.

An outer shape of the housing 11 is formed, for example, in a rectangular frame shape. The housing 11 is provided, for example, so as to surround an upper side in an upward-downward direction, and an inner side and an outer side in a direction orthogonal to the upward-downward direction of the coil 13, the insulation member 14, and the core member 15 described later. The housing 11 accommodates the coil 13, the insulation member 14, and the core member 15 described later and is integrally fixed to the rear surface of the lid MC of the manhole MH.

An outer shape of the first cover 12 is formed, for example, in a rectangular plate shape in which a penetration hole 12a is formed in a thickness direction. The first cover 12 is provided, for example, so as to surround a lower side in the upward-downward direction of the coil 13, the insulation member 14, and the core member 15 described later. The first cover 12 forms an accommodation space in which the coil 13, the insulation member 14, and the core member 15 are accommodated between an inner surface of the housing 11 and the first cover 12. The housing 11 and the first cover 12 sandwich the coil 13, the insulation member 14, and the core member 15 from both sides in the upward-downward direction.

An outer shape of the coil 13 is formed, for example, in a spiral shape along the inner surface of the housing 11.

An outer shape of the insulation member 14 is formed, for example, in a rectangular sheet shape in which a penetration hole 14a is formed in the thickness direction. The insulation member 14 is formed of a material having an electric insulation property.

An outer shape of the core member 15 is formed, for example, in a rectangular plate shape in which a penetration hole 15a is formed in the thickness direction. The core member 15 is formed of, for example, a magnetic material having relatively large permeability such as an electromagnetic steel sheet such as a silicon steel sheet or a ferrite.

The coil 13, the insulation member 14, and the core member 15 are sequentially laminated along the upward-downward direction and are arranged inside the housing 11.

An outer shape of the back member 16 is formed, for example, in a rectangular plate shape in which a penetration hole is formed in the thickness direction. An outer shape of the inner member 17 is formed, for example, in a box shape that includes a wall portion having a rectangular frame shape and a lid portion that closes an upper open end of the wall portion. The inner member 17 protrudes, for example, upward in the upward-downward direction from a circumferential edge portion that surrounds the penetration hole of the back member 16. The back member 16 and the inner member 17 are integrally formed of, for example, a magnetic material such as an electromagnetic steel sheet such as a silicon steel sheet.

The back member 16 is arranged, for example, on a lower side in the upward-downward direction relative to the first cover 12.

The inner member 17 is inserted, for example, in the penetration holes 12a, 15a, 14a of the first cover 12, the core member 15, and the insulation member 14, an empty core region 13a of the coil 13, and a penetration hole 11a in the thickness direction of the housing 11. The inner member 17 protrudes, for example, upward from an upper surface 11A of the housing 11 and is inserted into a penetration hole in the thickness direction of the lid MC of the manhole MH. An upper surface of the inner member 17 is exposed, for example, to the outside from a front surface of the lid MC of the manhole MH and forms an identical plane with the front surface of the lid MC and a road surface of the travel path.

An outer shape of the second cover 18 is formed, for example, in a hipped roof shape. The second cover 18 closes, for example, an open end of an accommodation portion of the housing 11 that accommodates an electric device such as a board and a capacitor.

An outer shape of the support member 19 is formed, for example, in a rectangular plate shape. The support member 19 is formed of, for example, a resin material. The support member 19 is arranged, for example, on a lower side in the upward-downward direction relative to the back member 16.

Since the coil unit 10 is fixed to the lower surface (rear surface) of the lid MC of the manhole MH, when the lid MC is removed from an upper open end E of the manhole MH, the coil unit 10 is brought out from the inner space H of the manhole MH. When the inner space of the manhole MH is opened to the outside by the removal of the lid MC, various devices, members, and the like that constitute the electric power transmission apparatus of the contactless electric power transmission system and are accommodated in the inner space H of the manhole MH are exposed to the outside.

As described above, according to the coil unit 10 of the embodiment, by including the housing 11 that is fixed to the rear surface of the lid MC of the manhole MH, for example, it is possible to prevent a direct load by a vehicle on the travel path or the like from acting and improve durability while ensuring a desired output and efficiency of charging and electric power supply. The housing 11 is integrally fixed to the lid MC and can be therefore easily exposed to the outside by being removed together with the lid MC. Further, for example, various devices, members, and the like that are arranged in the inner space H of the manhole MH can be easily exposed to the outside by the removal of the lid MC. Thereby, it is possible to improve ease of various maintenance work.

For example, compared to the case where the coil unit 10 is buried under an asphalt or concrete pavement, for example, in the ground, or the like, it is possible to prevent a decrease of a so-called Q value (a quality coefficient Q), and it is possible to prevent an increase of a distance between the coil unit 10 and the electric power reception device T mounted on a movable body such as a vehicle. By preventing the increase of a magnetic path length, it is possible to improve the output and efficiency of contactless electric power transmission. By including the inner member 17 that is exposed to the outside from the surface of the lid MC, it is possible to prevent a decrease in the efficiency of electric power transmission.

In addition to the coil unit 10, for example, various devices, members, and the like that constitute the electric power transmission apparatus of the contactless electric power transmission system can be arranged, for example, inside the cylindrical member buried in the ground such as an existing manhole MH or a hand-hole.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and gist of the invention and are also included within the scope of the invention described in the appended claims and equivalents thereof.

What is claimed is:

1. A coil unit comprising:
a coil that transmits electric power in a contactless manner to an electric power reception device; and
a housing that accommodates the coil,
wherein the housing is fixed inside a hole portion formed in a travel path to a lid portion which closes an open end of the hole portion.

2. The coil unit according to claim 1, comprising:
an inner member that is inserted in an empty core region of the coil and protrudes to an outside through the housing,
wherein a surface of the inner member is exposed to the outside from a surface of the lid portion.

3. The coil unit according to claim 1,
wherein the hole portion is formed of a cylindrical member buried in a ground, and
the lid portion closes an open end of the cylindrical member.

4. The coil unit according to claim 2,
wherein the hole portion is formed of a cylindrical member buried in a ground, and
the lid portion closes an open end of the cylindrical member.
